(19) United States
(12) Patent Application Publication
(10) Pub. No.: US 2008/0076408 A1
(43) Pub. Date: Mar. 27, 2008

(54) Wireless communications system, terminal and base station

(76) Inventors: Rintaro Katayama, Kokubunji (JP); Toshiyuki Saito, Kokubunji (JP); Shiro Mazawa, Fujisawa (JP); Daigo Takayanagi, Yokohama (JP)

Correspondence Address: REED SMITH LLP, Suite 1400, 3110 Fairview Park Drive, Falls Church, VA, 22042, US

(21) Appl. No.: 11/896,996

(22) Filed: Sep. 7, 2007

(30) Foreign Application Priority Data
Apr. 6, 2007 (JP) 2007-100024
Sep. 8, 2006 (JP) 2006-243522

(51) Int. Cl. H04Q 7/20

(52) U.S. Cl. 455/424; 455/422.1

(57) ABSTRACT

A wireless communications system, a terminal, and a base station that, when a terminal has not transmitted data for a predetermined period of time, suppress the transmission power, used when the terminal starts data transmission, by performing transmission power control that makes it easy for the terminal to decrease, or difficult for the terminal to increase, the transmission T2P or that, when a terminal that has not transmitted data for a predetermined period of time requests a sector to assign resources for data transmission, suppress the transmission power, used when the terminal starts data transmission, by transmitting a resource assignment message from the sector to the terminal to instruct the terminal to decrease the transmission power when the terminal starts data transmission.

### CLAIM OF PRIORITY

The present application claims priority from Japanese applications JP-2007-100024 filed on Apr. 6, 2007 and JP-2006-243522 filed on Sep. 8, 2006 the contents of which are hereby incorporated by reference into this application.

### BACKGROUND OF THE INVENTION

The present invention relates to a wireless communications system that employs OFDM (Orthogonal Frequency Division Multiplex) for wireless communication and to a system for implementing cellular communication. This technology can prevent a rapid increase in the interference power to a base station that is a problem when data transmission is started.

Research and development of a wireless communications system that employs OFDM is under way. In OFDM, transmission data is created in the frequency domain, is converted to signals in the time domain via IFFT (Inverse Fast Fourier Transform), and is transmitted as wireless signals. The receiving side converts the signals in the time domain to the signals in the frequency domain through FFT (Fast Fourier Transform) to retrieve the original information. When communication is performed, the transmission power of a terminal on the reverse link must be controlled to control the interference power to a base station.

IEEE802.20, which is a standardization organization, proposes an OFDM-based wireless system, and IEEE C802.20-06/04 defines the reverse link power control method described above.

3GPP, which is a standardization organization, proposes an OFDM-based wireless system as LTE (Long Term Evolution), and 3GPP TR25.814 V7.0.0 (2006-06) defines the reverse link power control method described above.

3GPP2, which is a standardization organization, proposes an OFDM-based wireless system as LBC (Loosely Backwards Compatible), and 3GPP2 C30-20060731-040R4 defines the reverse link power control method described above.

The transmission power control of a terminal in LBC is that a terminal increases or decreases the T2P (Traffic-to-Pilot) gain ΔP according to the index OSI (Other Sector Interference), which indicates the interference to each sector, to adjust the transmission power of the OFDM signal. Here, a sector refers to a beam-based logical division unit of a base station, and a terminal directly communicates with a sector. A T2P gain, which indicates the magnitude of the CDMA pilot transmission power versus the magnitude of the OFDM data channel transmission power, is defined by the transmission power per OFDM sub-carrier, that is, by the power spectrum density.

The following describes the transmission power control based on OSI with reference to FIG. 15. First, each sector measures the interference power of an interference signal 1001 and the noise power and, based on the measured result, calculates IoT (Interference over Thermal). IoT refers to the ratio of the interference power, which is received by a sector from terminals whose RLSS (Reverse Link Serving Sector) is not the sector itself, to the noise power. An RLSS refers to a sector to which a terminal is to transmit data via the reverse link. Each sector determines the interference status as 0, 1, or 2 based on the calculated IoT and notifies this status to the terminal as the OSI. OSI=0 indicates low interference, OSI=1 indicates high interference, and OSI=2 indicates very high interference. The OSI is notified from a sector to a terminal via an OSI notification channel 1002 such as F-OSICH (Forward OSI Channel) or F-FOSICH (Forward Fast OSI Channel).

A terminal detects OSI transmitted from sectors defined as OSIMonitorSet and performs operation according to a policy that the T2P gain ΔP is increased when the OSI is 0 and the T2P gain ΔP is decreased when the OSI is 1 or 2. The OSIMonitorSet refers to a pre-defined set of neighboring sectors except the RLSS. More specifically, for each of the sectors included in the OSIMonitorSet, the terminal decides whether to increase or decrease the T2P gain ΔP based on the detected OSI, assigns weight to this value using the propagation attenuation from each sector to the terminal so that the contribution of a nearer sector becomes larger, and adds up the weighted values. Let the calculated value be Dw. If Dw is equal to or smaller than a threshold, the terminal decreases the T2P gain ΔP by a predetermined value.

If Dw is equal to or larger than another threshold, the terminal increases the T2P gain ΔP by a predetermined value. If Dw does not satisfy either condition, the terminal does not change the T2P gain ΔP. The operation described above controls the transmission power of a terminal as shown in FIG. 2 so that the transmission power per sub-carrier of a terminal near the center of a cell is increased and the transmission power per sub-carrier of a terminal distant from the center of a cell is decreased.

On the other hand, when a terminal has data to transmit, the terminal first requests the RLSS to assign the communication resources of the reverse link via an R-REQCH(Reverse Request Channel) 1003. The RLSS that receives the R-REQCH assigns the sub-carrier information and the packet format information, which will be used on the reverse link, to the terminal via an RLAM (Reverse Link Assignment Message) on an F-SCCH (Forward Shared Control Channel) 1004. The terminal transmits data via an R-DCH (Reverse Data Channel) 1005 using the resources specified by the RLAM.

### SUMMARY OF THE INVENTION

In the transmission power control such as the one described in the BACKGROUND OF THE INVENTION, there is a possibility that a terminal suddenly starts communication at a high rate and with a large power when data transmission is started if the interference received by the neighboring sectors is small. Therefore, the interference given to non-RLSS sectors from the terminal increases more rapidly when data transmission is started than when data is being transmitted and, so, the communication quality such as PER (Packet Error Rate) is sometimes degraded. This is because each sector decides the OSI based on the interference condition at a particular time without considering interference status variations after deciding the OSI and, so, there is sometimes a difference between the interference status of each sector at the time each sector sent an OSI notification and the interference status of each sector at the time each terminal performs communication using the transmission power decided based on the OSI detected by the terminal.

For example, when a terminal starts data transmission immediately after each sector sent an OSI to the terminal, the interference power received by each sector becomes larger than when the OSI notification was sent to the terminal. In such a case, the S/I (Signal-to-Interference) ratio assumed when the OSI was decided cannot be achieved with the result that the reception PER in the sector is degraded. The S/I ratio is a ratio between the signal power and the interference power. The following describes an example of communication quality degradation with reference to FIG. 16. In FIG. 16, the RLSS of terminals AT1 and AT2 is base station AP1, and the RLSS of terminal AT3 is base station AP3. Because terminals AT1 and AT2 are not performing data transmission and the received interference power of base stations AP2 and AP3 is small, base stations AP2 and AP3 notifies OSI=0 to them. Based on OSI=0 received from base stations AP2 and AP3, terminals AT1 and AT2 increase the T2P gain ΔP. Therefore, when terminals AT1 and AT2 start communication, they start data transmission with a large power. At this time, base stations AP2 and AP3 receive a rapidly-increasing interference power from terminals AT1 and AT2. Therefore, the reception S/I ratio of base station AP3, which receives data from terminal AT3, is rapidly decreased and the reception PER is degraded.

The problem described above is not generated in a system that employs CDMA. For example, in cdma2000 1x EV-DO (Evolution Data Optimized) introduced in 3GPP2 C.S0024-B, it is specified that low-rate, low transmission power communication be performed when a terminal starts data transmission. This feature prevents the reception power of a sector from increasing rapidly, and the communication quality from being degraded, when a terminal starts data transmission.

To solve the problem described above, the transmission power is controlled to be smaller when a terminal does not transmit data than when the terminal is transmitting data.

To solve the problem described above, the transmission power control is performed to make it easier to decrease the T2P gain ΔP when a terminal does not transmit data even if the interference power received by a sector is small. That is, because the T2P gain ΔP is suppressed while the terminal does not transmit data, this control prevents the terminal from suddenly transmitting data with a large power. Therefore, when the terminal starts transmitting data, this control can prevent a rapid increase in the power received by a sector and avoids degradation in communication quality. Thus, the problem is solved.

To solve the problem described above, when a terminal starts transmitting data, the data transmission destination sector instructs the terminal to decrease the T2P gain ΔP. In response to the instruction, the terminal starts transmitting data with a suppressed transmission power based on the T2P gain ΔP decreased by a predetermined amount. This control can prevent a rapid increase in the power received by a sector, when the terminal starts transmitting data, and avoids degradation in communication quality. Thus, the problem is solved.

The present invention, which suppresses the transmission power when a terminal starts transmitting data, prevents a rapid increase in the interference power received by a sector and keeps communication quality while utilizing the framework of the conventional OSI-based power control mechanism.

The present invention optimizes the transmission power control of a reverse link especially in OFDMA-based cellular communication, thus preventing degradation in communication quality.

Other objects, features and advantages of the invention will become apparent from the following description of the embodiments of the invention taken in conjunction with accompanying drawings.

### BRIEF DESCRIPTION OF THE DRAWINGS

FIG. 1 is a diagram showing the configuration of an OFDM cellular system.

FIG. 2 is a diagram showing a trend in the transmission T2P gain of a terminal according to OSI-based transmission power control.

FIG. 3 is a flowchart showing how a terminal decides the transmission T2P gain according to OSI-based transmission power control.

FIG. 4 is a flowchart showing how a terminal decides the transmission T2P gain according to OSI-based transmission power control.

FIG. 5 is a flowchart showing how a terminal decides the transmission T2P gain in a first embodiment of the present invention.

FIG. 6 is a flowchart showing how a terminal decides the transmission T2P gain in the first embodiment of the present invention.

FIG. 7 is a flowchart showing how a terminal decides the transmission T2P gain in a second embodiment of the present invention.

FIG. 8 is a flowchart showing how a terminal decides the transmission T2P gain in the second embodiment of the present invention.

FIG. 9 is a flowchart showing how a terminal decides the transmission T2P gain in a third embodiment of the present invention.

FIG. 10 is a flowchart showing how a terminal decides the transmission T2P gain in the third embodiment of the present invention.

FIG. 11 is a diagram showing the sequence of information exchanged among the devices in a fourth embodiment of the present invention.

FIG. 12 is a diagram showing an RLAM message in the fourth embodiment of the present invention.

FIG. 13 is a diagram showing the configuration of the terminal of the present invention.

FIG. 14 is a diagram showing the configuration of a base station of the present invention.

FIG. 15 is a diagram showing the sequence of information exchanged among the devices according to OSI-based transmission power control.

FIG. 16 is a diagram showing characteristic deterioration involved in a transmission power increase that is the problem in OSI-based transmission power control.

### DETAILED DESCRIPTION OF THE INVENTION

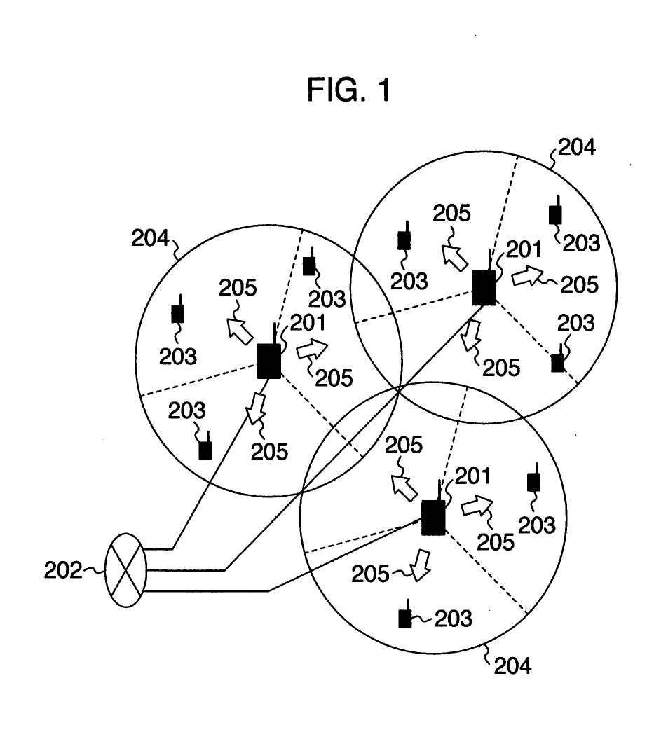

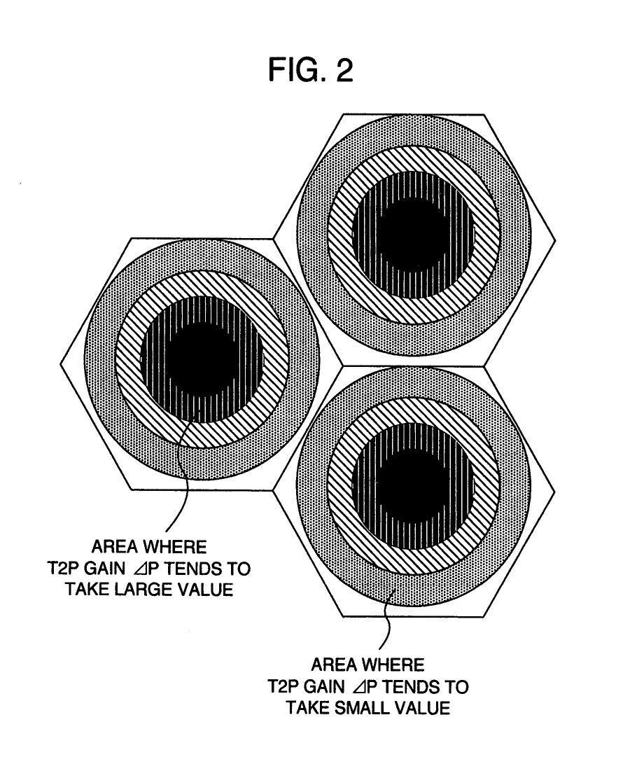

In general, an OFDM cellular wireless communication system comprises multiple base station devices and multiple terminals as shown in FIG. 1. A base station device 201 is connected to a network 202 via a wired line. A terminal 203 is connected to the base station device 201 wirelessly for communication with the network 202.

Each sector in an OFDM cellular base station receives signals from terminals that are communicating with this sector, interference signals from terminals that are communicating with other sectors, and noises. Each sector measures the interference power and the noise power and calculates the ratio between them to obtain the IoT for the sector. Based on the calculated IoT, each sector decides the intensity of interference it receives as OSI at one of three levels, 0, 1, and 2. OSI=0, which indicates that the interference power is small, is a numeric value notifying a terminal, which is the interference source of each sector, that the transmission T2P gain ΔP may be increased. OSI=1 and OSI=2, which indicate that the interference power is large, are numeric values requesting a terminal, which is the interference source of each sector, to decrease the transmission T2P gain ΔP. In particular, OSI=2, which indicates that the interference is very high, is provided to force a terminal, which is the interference source of each sector, to decrease the transmission T2P gain ΔP. Each sector notifies OSI to a terminal via F-OSICH and F-FOSICH.

FIG. 14 shows an example of the configuration of a base station for carrying out the present invention. An antenna 801 receives a signal from a terminal, an RF unit 802 measures the received interference power and the noise power, a control unit (MPU) 806 calculates the IoT and decides the OSI value. The decided OSI value is input to a baseband unit 803. The baseband unit 803 performs OFDM signal processing such as channel encoding, modulation, IFFT, and CP (Cyclic Prefix) insertion. The digital signal generated by the baseband unit 803 is converted to the analog signal, up-converted to the transmission frequency band, and amplified to an appropriate transmission power by the RF unit 802, and is transmitted from the antenna 801.

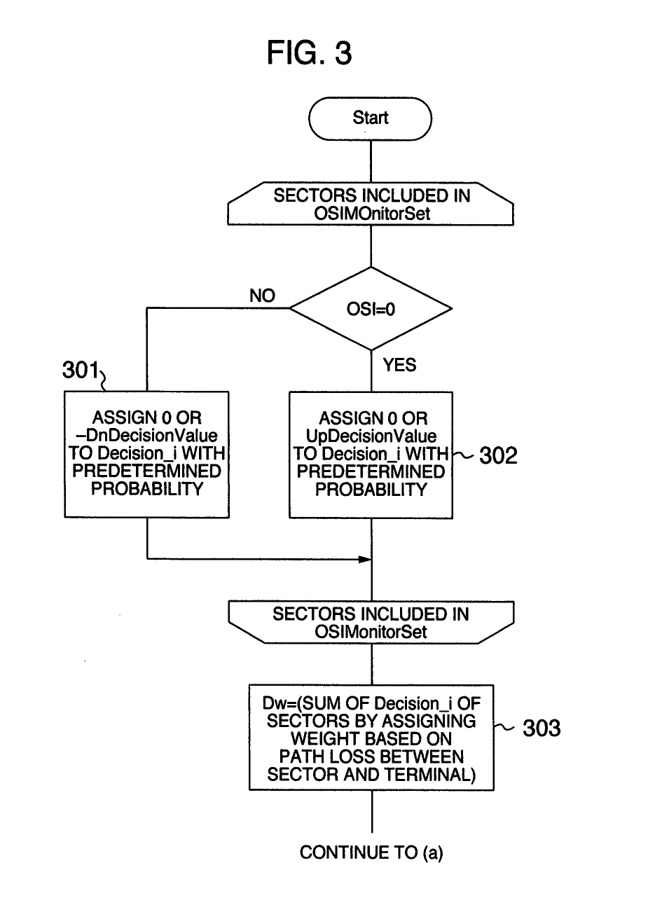

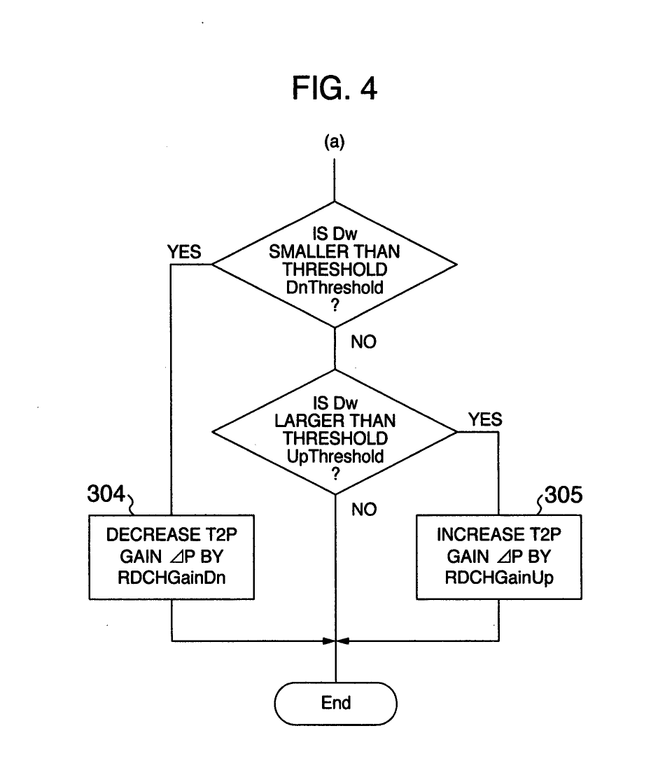

FIGS. 3 and 4 are flowcharts showing how a terminal decides the T2P gain ΔP from a received OSI. The terminal receives an OSI from each sector via the F-OSICH or F-FOSICH. A sector that is more distant from a terminal receives a smaller interference power from the terminal due to the propagation attenuation in the wireless domain. Therefore, the larger interference power of a sector tends to be caused by the signals received from the terminals which are near the sector but whose RLSS is not this sector. Thus, the terminal detects OSIs from the neighboring sectors predefined as the OSIMonitorSet. The terminal detects the OSI of each sector included in the OSIMonitorSet and converts the OSI value from each sector to Decision_i that is the power increase/decrease parameter of each sector. More specifically, when OSI=0, the terminal sets Decision_i to 0 or UpDecisionValue with a predetermined probability and, when OSI=1 or OSI=2, sets Decision_i to 0 or −DnDecisionValue with a predetermined probability. UpDecisionValue and DnDecisionValue are predetermined values related to the T2P gain increase amount and the T2P gain decrease amount, respectively. After that, the terminal sums up Decision_i of all sectors, included in the OSIMonitorSet, by assigning a weight based on the propagation attenuation on the wireless link between each sector and the terminal. The resulting value is Dw. If Dw is smaller than the threshold DnThreshold, the terminal decreases the T2P gain ΔP by a predetermined fixed amount (RDCHGainDn) and, if Dw is larger than the threshold UpThreshold, the terminal increases the T2P gain ΔP by a predetermined fixed amount (RDCHGainUp). If Dw satisfies none of the conditions, the terminal does not change T2P gain ΔP. DnThreshold and UpThreshold are thresholds used to determine if the power should be decreased or increased. The terminal determines the transmission power of the OFDM sub-carrier based on the decided T2P gain ΔP and the pilot power of the CDMA signal to transmit the control channel.

When a terminal transmits data to a sector, the terminal first uses an R-REQCH(Reverse Request Channel) to request the sector to assign the frequency/time resources for transmitting data. The R-REQCH includes information such as the buffer size of transmission data transmitted by the terminal. In response to the R-REQCH from the terminal, the sector decides the frequency/time resources to be assigned to the terminal and, based on them, creates a resource assignment information message RLAM (Reverse Link Assignment Message). The RLAM, a message used by the sector to notify the terminal about sub-carrier information and packet format information to be used by the terminal on the reverse link, is transmitted from the sector to the terminal using the F-SCCH (Forward Shared Control Channel). The terminal uses the resources, notified via the RLAM, to transmit data to the sector.

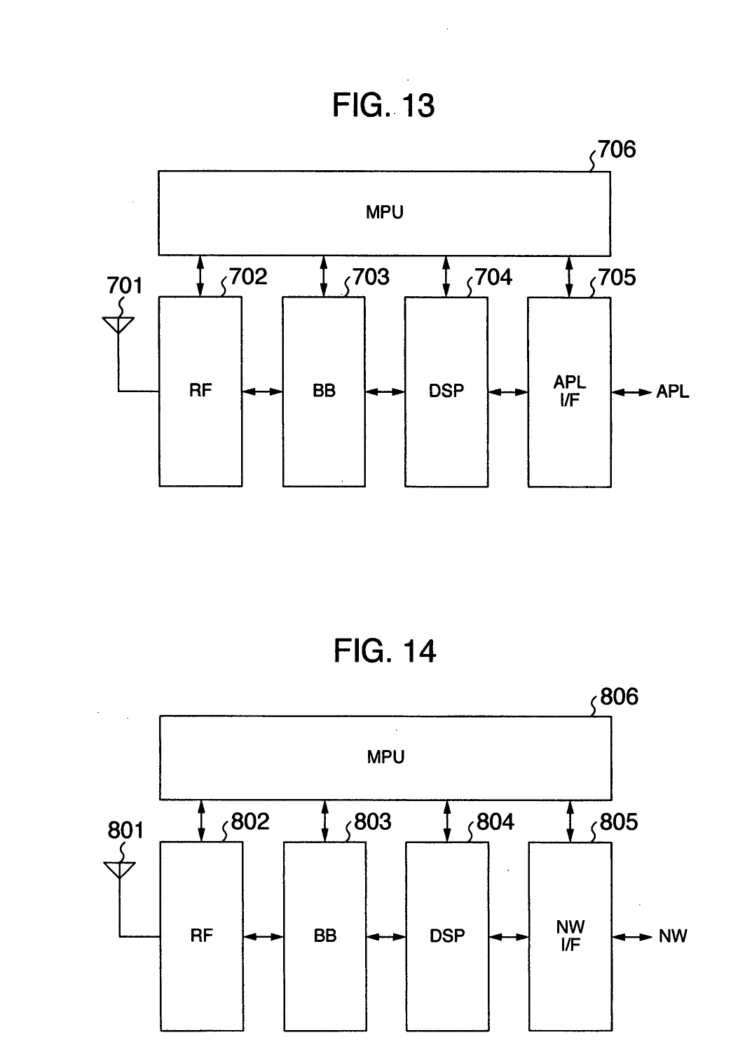

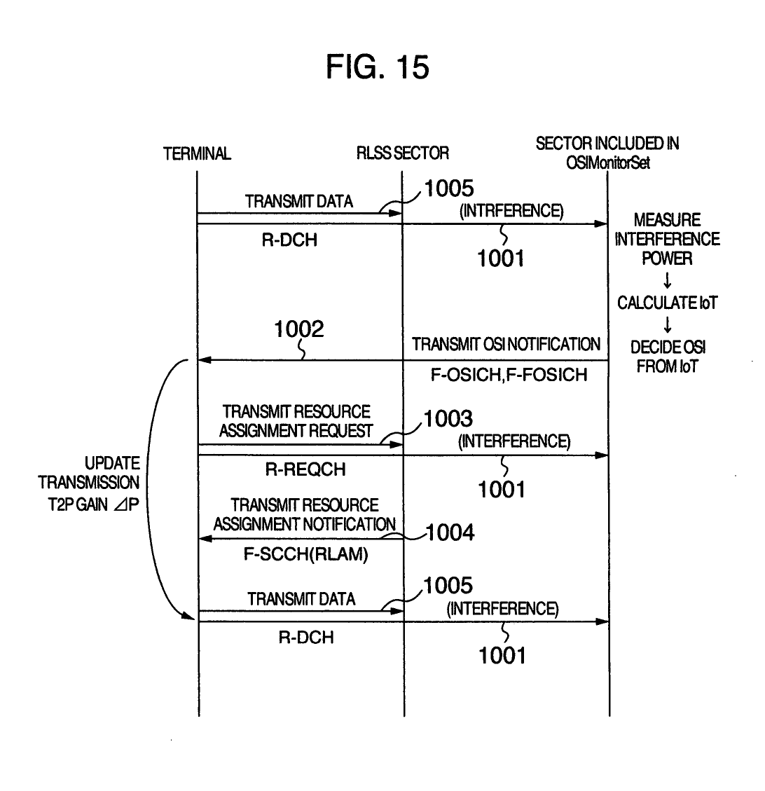

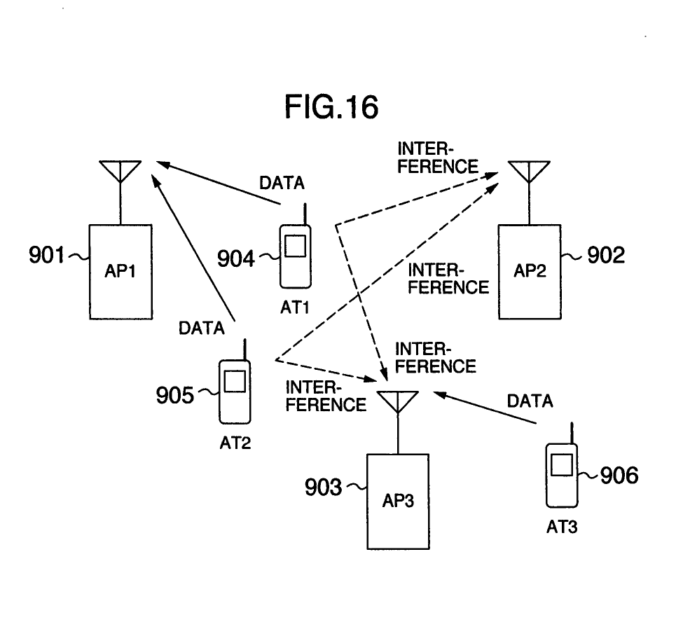

FIG. 13 shows an example of the configuration of a terminal for carrying out the present invention. An antenna 701 receives a wireless signal from a base station. An RF unit 702 performs processing for the received signal such as down-conversion to the baseband signal and the conversion from the analog signal to the digital signal. After that, a baseband unit 703 performs processing such as FFT, propagation channel estimation, demodulation, and channel decoding and transmits the transmission data, acquired from the base station, to a DSP 704. The DSP 704 acquires the OSI value of the sector and, using the acquired OSI value, an MPU 706 performs T2P gain ΔP decision processing. The decided T2P gain ΔP value is used as the transmission power gain for the data channel when the baseband unit 703 OFDM-modulates the transmission data of the terminal.

### FIRST EMBODIMENT

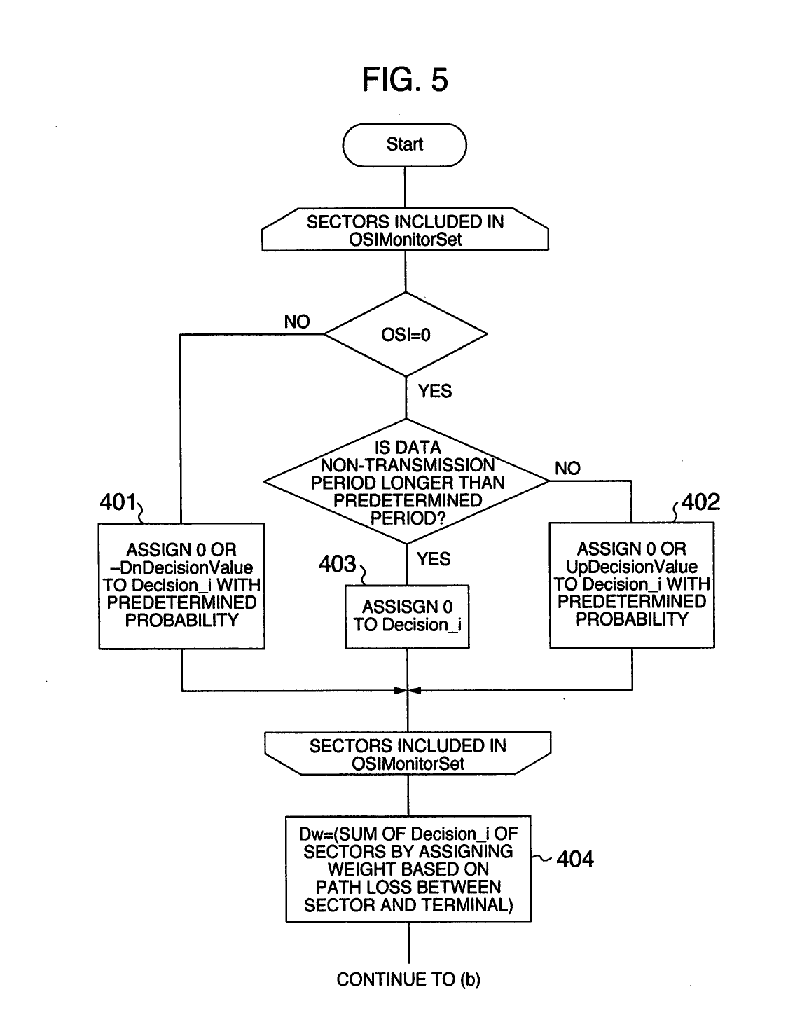

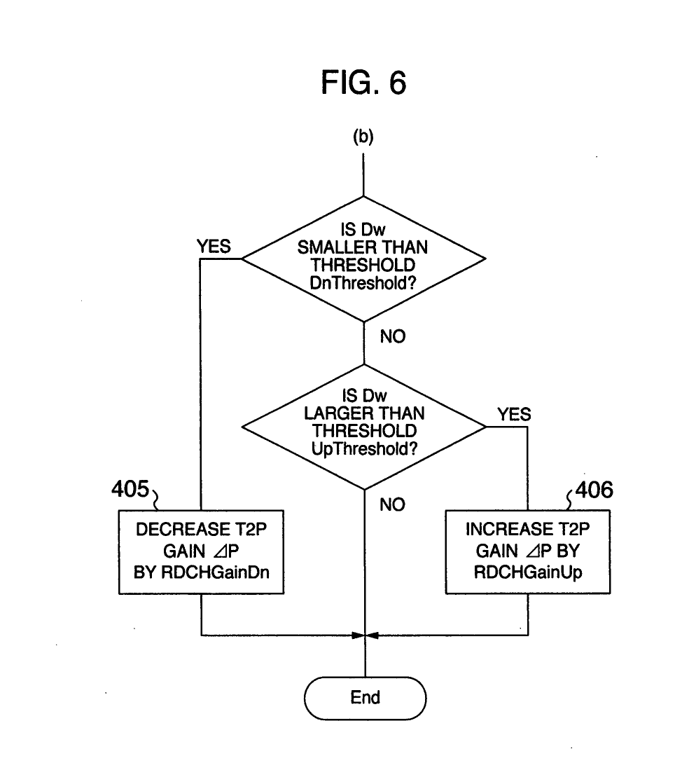

A first embodiment of the present invention will be described with reference to FIGS. 5 and 6. In the first embodiment, when a terminal has not transmitted data for a predetermined time, control is performed to make it difficult for the terminal to increase the T2P gain ΔP even if a sector notifies OSI=0 to the terminal.

FIGS. 5 and 6 are flowcharts of the first embodiment of the present invention, and the processing shown in FIGS. 5 and 6 is performed by the terminal. The terminal detects the OSI received from each sector and, if OSI=0, sets Decision_i to 0 or UpDecisionValue with a predetermined probability for the sector when the terminal is transmitting data. However, when the terminal has not transmitted data for a predetermined time, the terminal sets Decision_i to 0. After that, the terminal sums up Decision_i of all sectors, included in the OSIMonitorSet, by assigning a weight based on the path loss between each sector and the terminal to calculate the sum value Dw. The terminal decides an increase/decrease in the T2P gain ΔP according to the value of Dw. The terminal increases the transmission T2P gain ΔP if Dw is larger than the threshold UpThreshold, decreases the transmission T2P gain ΔP if Dw is smaller than the threshold DnThreshold, and does not change the transmission T2P gain ΔP if Dw is larger than DnThreshold and smaller than UpThreshold.

In this embodiment, the value of Dw is smaller when data is not transmitted than when data is transmitted. This makes it more difficult for the transmission T2P gain ΔP to be increased, and makes it easier to be decreased, when data is not transmitted than when data is transmitted. As a result, because the OFDM sub-carrier transmission power of the terminal becomes smaller when data is not transmitted than when data is transmitted, the terminal starts data transmission with a smaller transmission power. Therefore, the fluctuation range in the interference power, received by the sectors other than the RLSS of the terminal that started the data transmission, is smaller than that in the conventional method and, so, the communication quality such as PER can be kept constant.

### SECOND EMBODIMENT

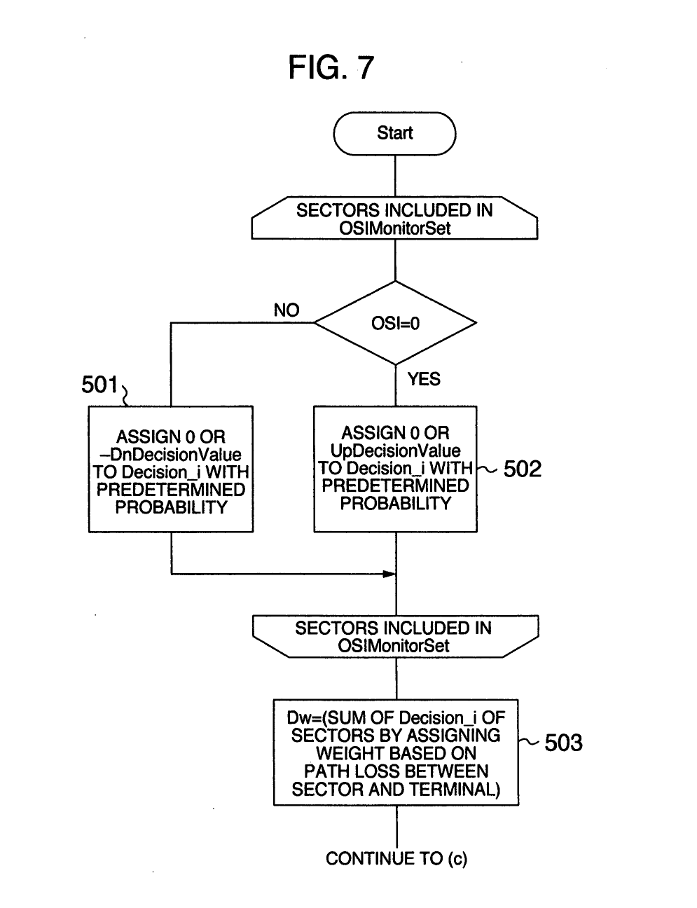

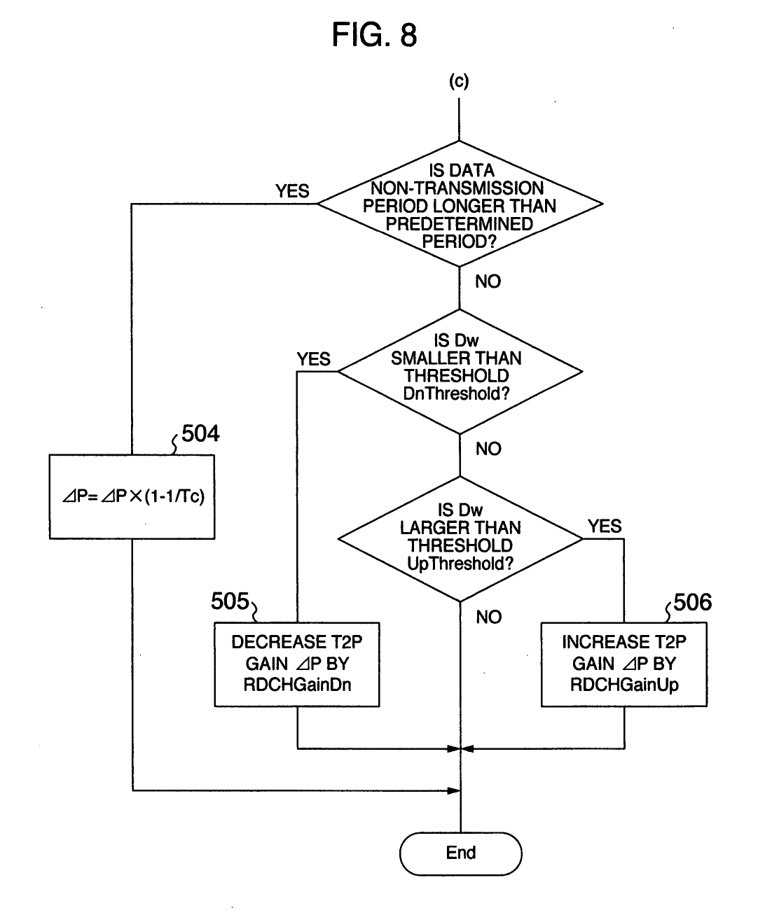

A second embodiment of the present invention will be described with reference to FIGS. 7 and 8. In the second embodiment, when a terminal has not transmitted data for a predetermined time, the terminal does not increase the T2P gain ΔP but decreases it by a time constant.

FIGS. 7 and 8 are flowcharts of the second embodiment of the present invention, and the processing shown in FIGS. 7 and 8 is performed by the terminal. The terminal detects the OSI received from each sector and, if OSI=0, sets Decision_i to 0 or UpDecisionValue with a predetermined probability and, if OSI=1 or OSI=2, the terminal sets Decision_i to 0 or −DnDecisionValue with a predetermined probability. After that, the terminal sums up Decision_i of all sectors, included in the OSIMonitorSet, by assigning a weight based on the path loss between each sector and the terminal to calculate the sum value Dw. The terminal decides an increase/decrease in the T2P gain ΔP according to the value of Dw. The terminal increases the transmission T2P gain ΔP if Dw is larger than the threshold UpThreshold, decreases the transmission T2P gain ΔP if Dw is smaller than the threshold DnThreshold, and does not change the transmission T2P gain ΔP if Dw is larger than DnThreshold and smaller than UpThreshold. However, if the terminal has not transmitted data for a predetermined time or longer, the terminal decreases the transmission T2P gain ΔP using a predetermined time constant Tc regardless of the Dw value.

In this embodiment, when data is not transmitted, the T2P gain ΔP is not increased. As a result, because the OFDM sub-carrier transmission power of the terminal becomes smaller when data is not transmitted than when data is transmitted, the terminal selects a smaller transmission power when it starts data transmission. Therefore, the fluctuation range in the interference power, received by the sectors other than the RLSS of the terminal that started the data transmission, is smaller than that in the conventional method and, so, the communication quality such as PER can be kept constant.

### THIRD EMBODIMENT

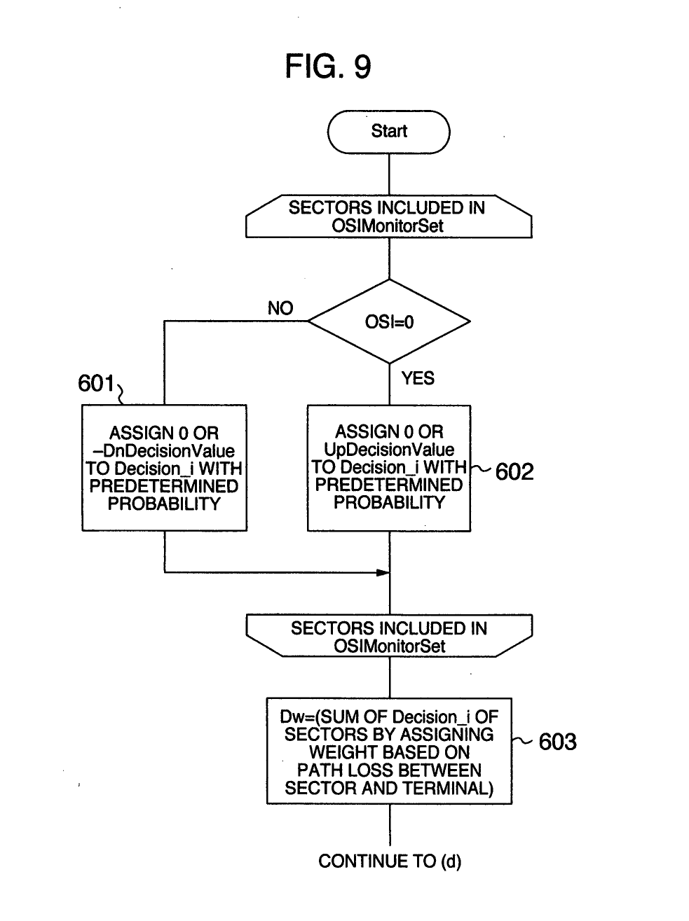

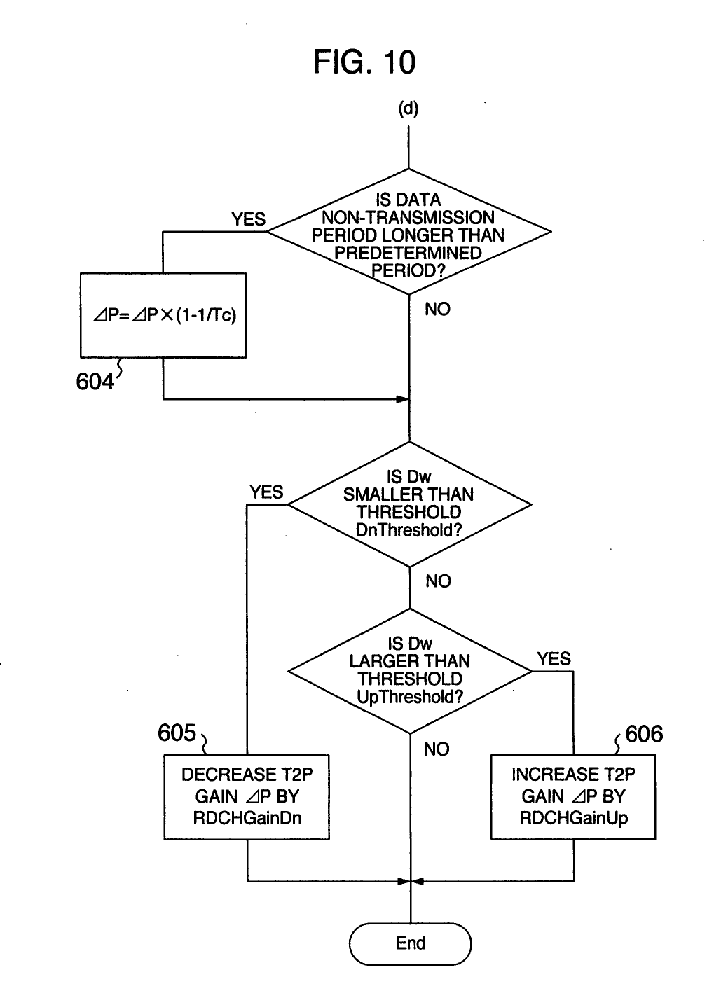

A third embodiment of the present invention will be described with reference to FIGS. 9 and 10. In the third embodiment, when a terminal has not transmitted data for a predetermined time, the terminal does not increase the T2P gain ΔP but decreases it by a time constant.

FIGS. 9 and 10 are flowcharts of the third embodiment of the present invention, and the processing shown in FIGS. 9 and 10 is performed by the terminal. The terminal detects the OSI received from each sector and, if OSI=0, sets Decision_i to 0 or UpDecisionValue with a predetermined probability and, if OSI=1 or OSI=2, the terminal sets Decision_i to 0 or —DnDecisionValue with a predetermined probability. After that, the terminal sums up Decision_i of all sectors, included in the OSIMonitorSet, by assigning a weight based on the path loss between each sector and the terminal to calculate the sum value Dw. If the terminal has not transmitted data for a predetermined time or longer, the terminal decreases the transmission T2P gain ΔP using a predetermined time constant Tc. If the terminal is transmitting data, the terminal does not change the transmission T2P gain. After that, the terminal increases or decreases the T2P gain ΔP according to the value of Dw. The terminal increases the transmission T2P gain ΔP if Dw is larger than the threshold UpThreshold, decreases the transmission T2P gain ΔP if Dw is smaller than the threshold DnThreshold, and does not change the transmission T2P gain ΔP if Dw is larger than DnThreshold and smaller than UpThreshold.

In this embodiment, when data is not transmitted, a decrement offset is applied to the change in the transmission T2P gain ΔP. As a result, because the OFDM sub-carrier transmission power of the terminal becomes smaller when data is not transmitted than when data is transmitted, the terminal selects a smaller transmission power when it starts data transmission. Therefore, the fluctuation range in the interference power, received by the sectors other than the RLSS of the terminal that started the data transmission, is smaller than that in the conventional method and, so, the communication quality such as PER can be kept constant.

### FOURTH EMBODIMENT

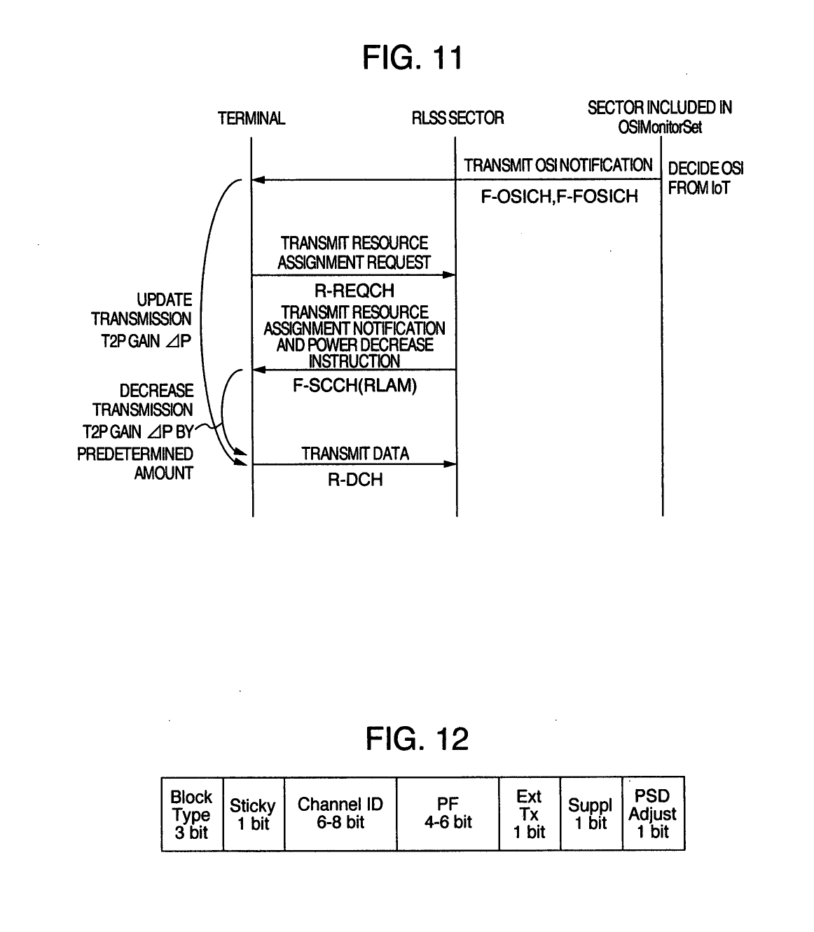

A fourth embodiment of the present invention will be described with reference to FIGS. 11 and 12. In the fourth embodiment, when a terminal starts data transmission, a sector instructs the terminal to decrease the T2P gain ΔP.

FIG. 11 shows the sequence diagram of the fourth embodiment of the present invention. Referring to FIG. 11, the following describes the procedure for suppressing the transmission T2P gain ΔP when a terminal starts data transmission in this embodiment. Each sector calculates IoT from the measured interference power and the noise power in the same way as in a publicly known example. Based on the IoT, each sector decides the interference information OSI and notifies it to the terminal via F-OSICH or F-FOSICH. The terminal receives OSIs from the sectors included in the OSIMonitorSet and, based on them, determines whether to increase or decrease the transmission T2P gain.

On the other hand, before the terminal transmits data over the reverse link, the terminal uses R-REQCH to request a sector, with which reverse link communication is to be performed, to assign resources for the data transmission. In response to the resource assignment request from the terminal, the sector checks whether or not the terminal transmitted data in a predetermined period of time. The sector decides the resources, which will be used by the terminal, and transmits an RLAM, which is a resource assignment message, to the terminal via the F-SCCH. The configuration of the RLAM message in this embodiment is shown in FIG. 12. The Block Type field indicates that this message is an RLAM. The Sticky field indicates whether this resource assignment is effective for only one packet or until the resource assignment is changed. The Channel ID field indicates the ID of sub-carriers to be used by the terminal to transmit data.

The PF (Packet Format) field indicates the packet format used by the terminal to transmit data. The Ext Tx (Extended Transmission) field indicates whether or not the extended transmission mode is used in which data is transmitted in multiple continuous time frames. The Suppl (Supplemental) field indicates whether or not the supplemental mode is used in which resources are additionally assigned. The PSD (Power Spectral Density) Adjust field indicates whether or not the terminal is to decrease the T2P gain by a fixed amount. When the terminal has not transmitted data for a predetermined period of time, the sector uses the PSD Adjust field of the RLAM to notify the terminal to decrease the T2P gain by a predetermined amount. Otherwise, the sector uses the PSD Adjust field of the RLAM to notify the terminal not to decrease the T2P gain by a fixed amount. The terminal receives the RLAM from the sector and uses the resources, specified in the RLAM message, to transmit data via the R-DCH(Reverse Data Channel). At this time, the transmission T2P gain ΔP is a value calculated by subtracting the fixed amount, predetermined according to the PSD Adjust field, from the ΔP value updated based on the OSI.

In this embodiment, when a terminal starts data transmission, a base station notifies the terminal to transmit data using the value, generated by decreasing a predetermined amount from the transmission T2P gain decided based on the OSI received by the terminal and, according to this notification, the terminal decreases the transmission T2P gain by the predetermined amount. As a result, the terminal uses a small transmission power when it starts data transmission. Therefore, the fluctuation range in the interference power, received by the sectors other than the RLSS of the terminal that started the data transmission, is smaller than that in the conventional method and, so, the communication quality such as PER can be kept constant.

It should be further understood by those skilled in the art that although the foregoing description has been on embodiments of the invention, the invention is not limited thereto and various change and modifications may be made without departing from the spirit of the invention and the scope of the appended claims.

1. A wireless communications system that is an OFDM cellular wireless communications system comprising a base station and a terminal wherein
a transmission signal power per OFDM sub-carrier on a reverse link from said terminal to said base station is set smaller when said terminal starts data transmission than when said terminal is transmitting data.

2. The wireless communications system according to claim 1 wherein
when said terminal receives a notification, which indicates that an interference power received by a sector is small, from said base station,
said terminal increases the transmission signal power according to the notification when said terminal is transmitting data and
said terminal transmits signals with a smaller transmission signal power when said terminal starts data transmission than when said terminal is transmitting data.

3. The wireless communications system according to claim 1 wherein
when said terminal receives a notification, which indicates that an interference power received by a sector is small, from said base station,
said terminal increases the transmission signal power according to the notification when said terminal is transmitting data and
said terminal transmits signals with a smaller transmission signal power when said terminal has not transmitted data for a predetermined period of time than when said terminal is transmitting data.

4. The wireless communications system according to claim 1 wherein
when said terminal receives a notification, which indicates that an interference power received by a sector is small, from said base station,
said terminal increases the transmission signal power according to the notification when said terminal is transmitting data and
said terminal transmits signals with a transmission signal power generated by decreasing the transmission signal power, which is used when said terminal is transmitting data, by a predetermined time constant when said terminal has not transmitted data for a predetermined period of time.

5. The wireless communications system according to claim 1 wherein
when said terminal receives a notification, which indicates that an interference power received by a sector is small, from said base station,
said terminal increases the transmission signal power according to the notification when said terminal is transmitting data and
said terminal decreases the transmission signal power by a predetermined time constant and, after that, increases the transmission signal power according to the notification when said terminal has not transmitted data for a predetermined period of time.

6. The wireless communications system according to claim 1 wherein
when said base station transmits a notification, which indicates that an interference power received by a sector is small, to said terminal,
said base station transmits the notification to said terminal when said terminal is transmitting data and
said base station transmits the notification as well as an instruction, which requests said terminal to transmit signals with a power smaller by a predetermined amount than a power increased according to the notification, to said terminal when said terminal has not transmitted data for a predetermined period of time.

7. A terminal that communicates with a base station via an OFDM cellular wireless communications system wherein
when said terminal receives a notification, which indicates that an interference power received by a sector is small, from said base station,
said terminal increases a transmission signal power according to the notification when said terminal is transmitting data and
said terminal transmits signals with a smaller transmission signal power when said terminal has not transmitted data for a predetermined period of time than when said terminal is transmitting data.

8. A terminal that communicates with a base station via an OFDM cellular wireless communications system wherein
when said terminal receives a notification, which indicates that an interference power received by a sector is small, from said base station,
said terminal increases a transmission signal power according to the notification when said terminal is transmitting data and
said terminal transmits signals with a transmission signal power generated by decreasing the transmission signal power, which is used when said terminal is transmitting data, by a predetermined time constant when said terminal has not transmitted data for a predetermined period of time.

9. A terminal that communicates with a base station via an OFDM cellular wireless communications system wherein
when said terminal receives a notification, which indicates that an interference power received by a sector is small, from said base station,
said terminal increases a transmission signal power according to the notification when said terminal is transmitting data and
said terminal decreases the transmission signal power by a predetermined time constant and, after that, increases the transmission signal power according to the notification when said terminal has not transmitted data for a predetermined period of time.

10. A base station that communicates with a terminal via an OFDM cellular wireless communications system wherein
when said base station transmits a notification, which indicates that an interference power received by a sector is small, to said terminal,
said base station transmits the notification to said terminal when said terminal is transmitting data and
said base station transmits the notification as well as an instruction, which requests said terminal to transmit signals with a power smaller by a predetermined amount than a power increased according to the notification, to said terminal when said terminal has not transmitted data for a predetermined period of time.
